(19) United States
(12) Patent Application Publication
(10) Pub. No.: US 2026/0245425 A1
(43) Pub. Date: Aug. 20, 2026

(54) GAMING AND MEDIA ENTERTAINMENT LIVEOPS NETWORK

(71) Applicant: Aristocrat Technologies, Inc., Las Vegas, NV (US)

(72) Inventor: Robert Butler, Austin, TX (US)

(21) Appl. No.: 19/540,212

(22) Filed: Feb. 13, 2026

Related U.S. Application Data
(60) Provisional application No. 63/759,974, filed on Feb. 18, 2025.

(51) Int. Cl. G07F 17/32; G07F 17/34

(52) U.S. Cl. CPC G07F 17/3213; G07F 17/323; G07F 17/3234; G07F 17/34

(57) ABSTRACT

Techniques include a head end system that dynamically receives communication signals associated with media data from an administrative network, determines a deployment schedule based on the signals, and drives electronic gaming device displays to present the media data. The deployment schedule includes rules for displaying the signals, which are based on the outcomes of the gaming machines. Techniques also include driving additional displays separate from the gaming machines. The head end system is located within a casino environment and used to drive displays within the casino environment. The administrative network uses the head end system at multiple casino environments to manage a multi-site progressive.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome, and symbols are then selected which correspond to that outcome. Notably, some games may include an element of skill on the part of the player and are therefore not entirely random.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts a system diagram of a gaming network architecture, in accordance with one or more embodiments.

FIG. 5 depicts a system diagram of a head end system, in accordance with one or more embodiments.

FIG. 6 depicts a flowchart of a technique for using a head end system to drive multiple displays, in accordance with one or more embodiments.

FIG. 7 illustrates example network diagram for a multi-platform gaming architecture, in accordance with one or more embodiments.

FIG. 8 depicts a flow diagram for facilitating a multi-site progressive, in accordance with one or more embodiments.

### DETAILED DESCRIPTION

The disclosure generally describes a gaming architecture that expands the media distribution by allowing the gaming architecture to dynamically push desired content to many different display types. Specifically, the gaming architecture allows a casino operator to push scheduled content to a designated location onto different display types such as sky domes, large media walls, floor displays, EGM toppers and signages and EGM displays.

Traditionally, a media player device is connected to a bank of EGMs to drive and present content on multiple display devices. The media player device is connected and drives a fixed number of display devices, and the content is preloaded and dynamically changes. Embodiments described herein replace at least some of the functionality of the media player device by providing a head end system configured to manage multiple displays and devices within a casino, such that the head end system can manage not only display, but other data transfer, across numerous devices within a physical gaming environment, both across multiple banks, and including non-gaming devices, such as non-gaming displays within the physical gaming environment.

The techniques described herein offload existing software and hardware stacks to a remote administrative network. The content is driven from a centralized environment that supplies contents to the different displays at each EGM bank and other displays located across the casino. In doing so, the architecture improves latency and flexibility of casino-based gaming architectures.

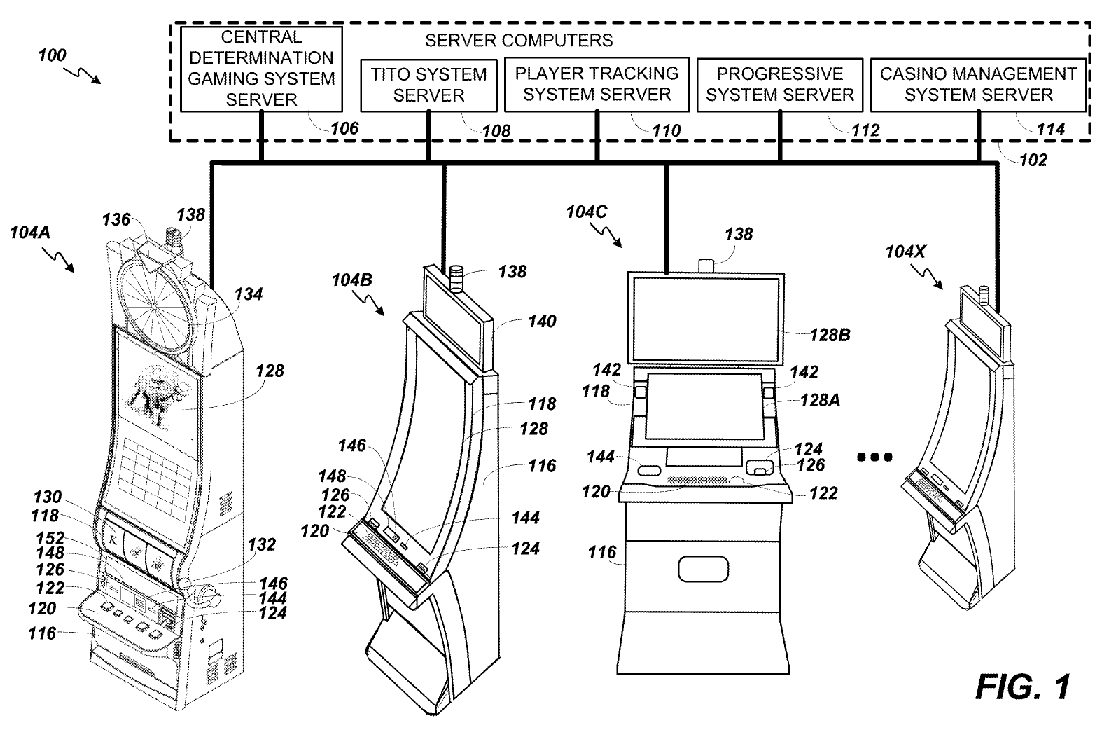

FIG. 1 illustrates several different models of EGMs which may be networked to various gaming-related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system (CMS) 114, which may include one or more servers. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL^{TM} model gaming device manufactured by Aristocrat^{®} Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player’s smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

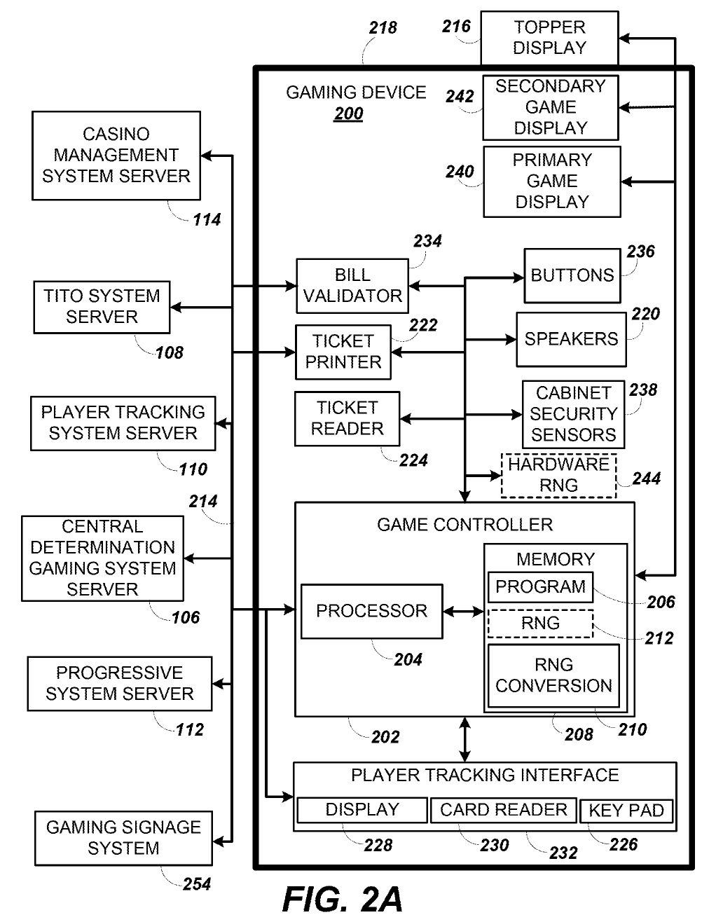

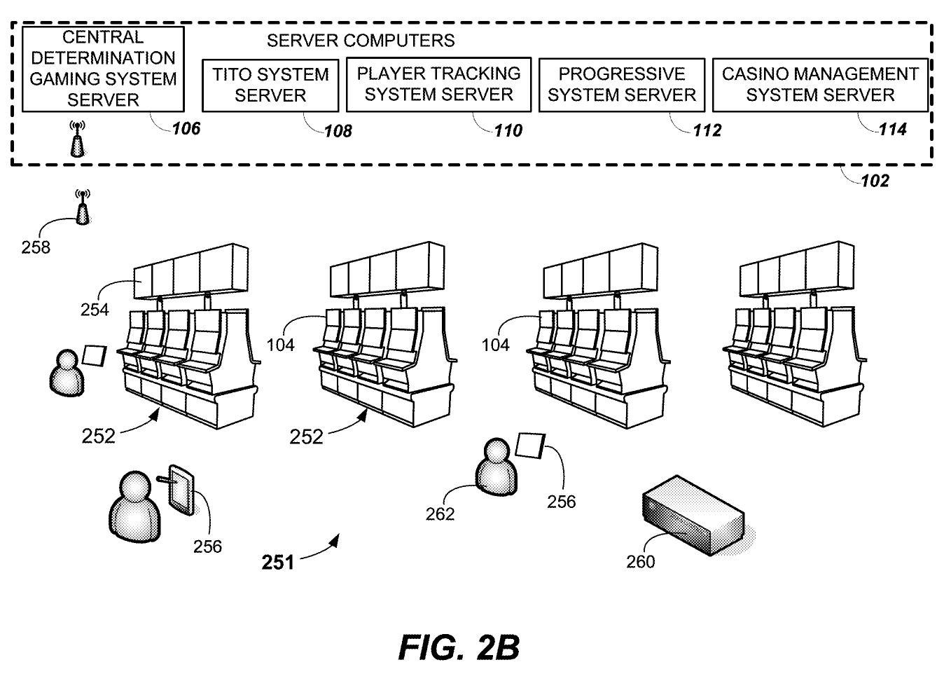

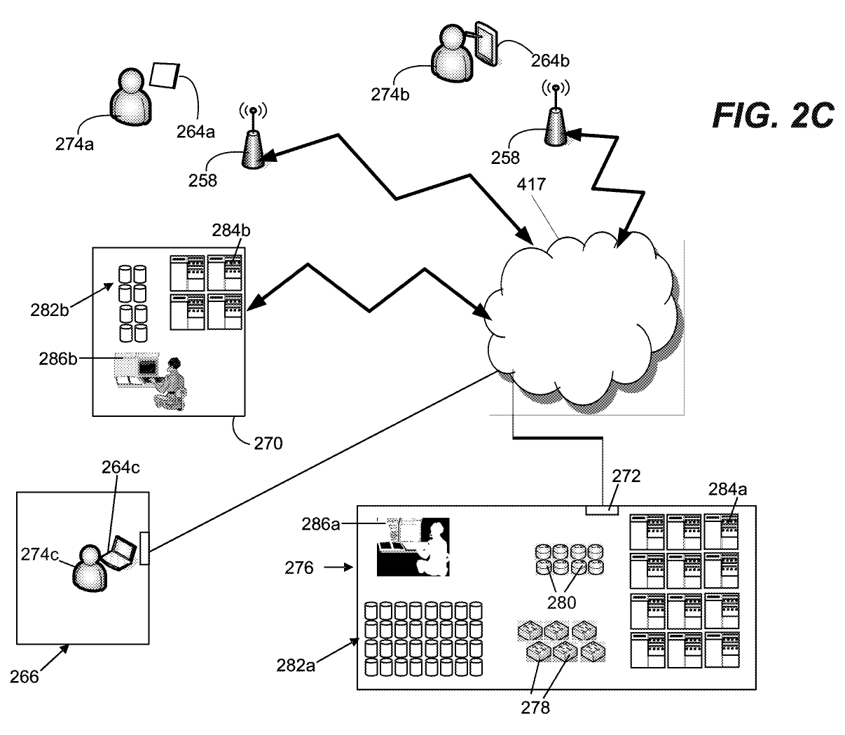

Many or all of the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc^{TM} model gaming device manufactured by Aristocrat^{®} Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix^{TM} model gaming device manufactured by Aristocrat^{®} Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class II or Class III, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player’s credit value, a ticket reader 224 which reads bar-coded tickets or other media or mechanisms for storing or indicating a player’s credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that does not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide computer readable code such as program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS^{®} system manufactured by Aristocrat^{®} Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system (CMS).

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during the course of game play (such as spinning a wheel to begin a bonus round or selecting various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron’s player loyalty card, a patron’s smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player’s EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a–274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player’s “cash in” selections, wagering game results and a player’s “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a–274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

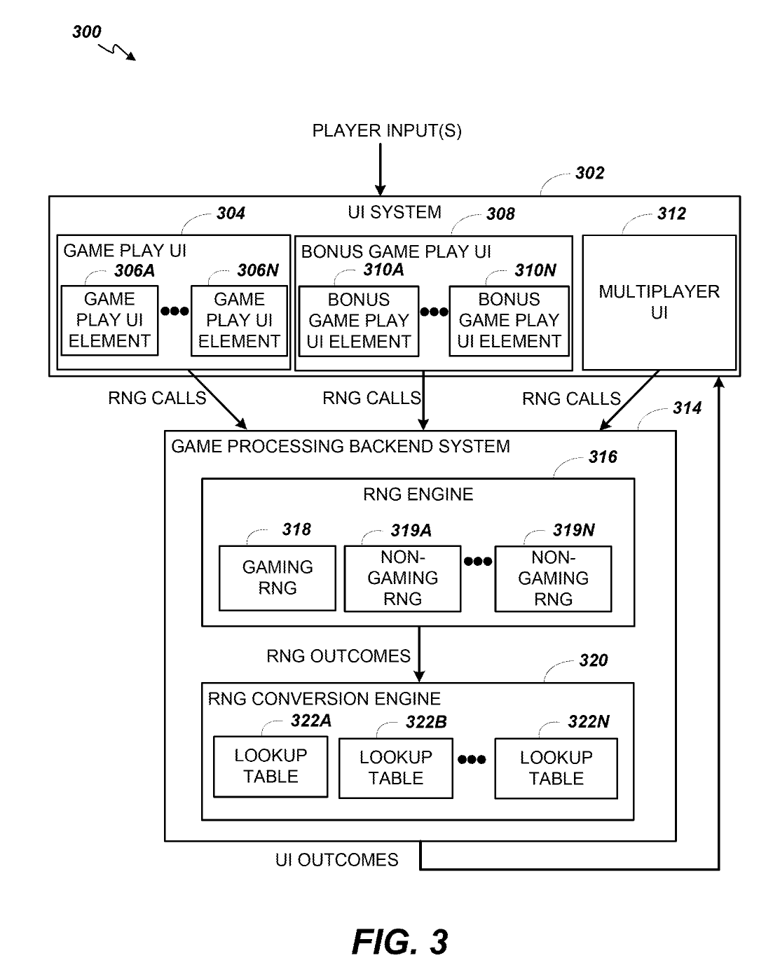

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI elements 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player input and/or present game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player’s gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

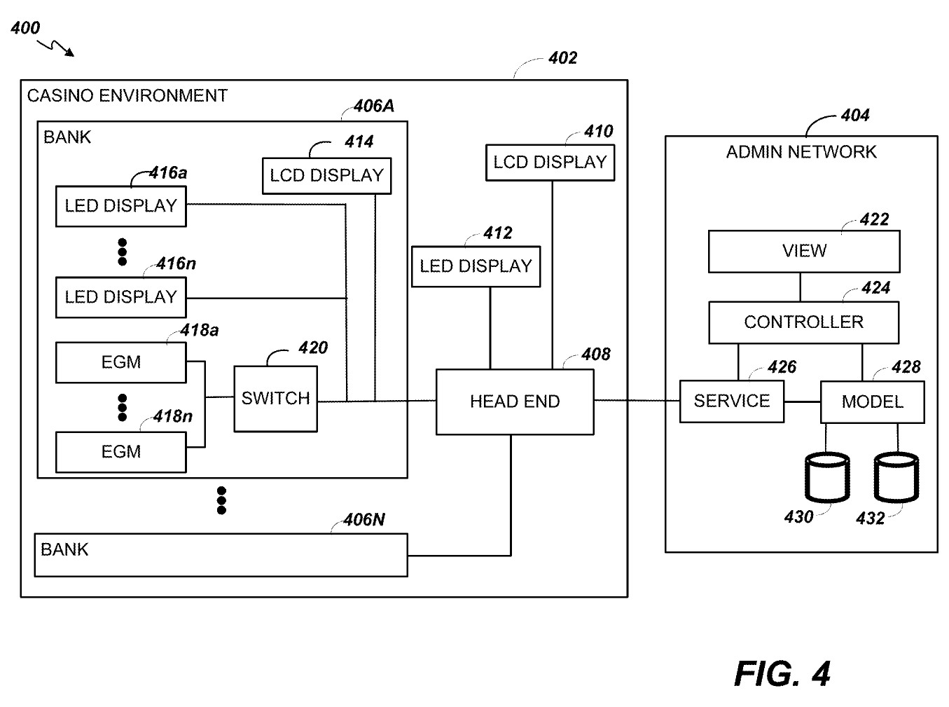

FIG. 4 depicts a system diagram for a gaming architecture that provides a head end system for a gaming environment, in accordance with one or more embodiments. In particular, system diagram 400 includes administrative network 404 serving a centralized role and connected to devices within the casino environment 402. Although not shown, administrative network 404 may be communicably connected to devices within multiple casino environments and/or other gaming devices. Administrative network 404 can provide content to devices within the casino environment 402 either prior to a time the data should be deployed, or on demand, such as in a live stream format. In addition, administrative network 404 may track performance data from casino environment 402 based on communication signals provided from the head end system 408. For example, the administrative network may provide media content to be presented on one or more devices, such as displays on EGMs, toppers, seating displays, bank displays, and the like. Media may also be provided to non-gaming displays within the environment, such as sky domes, media walls, floor displays, casino signage, and the like. In addition, the administrative network 404 can be configured to provide gaming data, such as updates for EGMs or other devices within the environment, which is to be deployed on a schedule, for example a time-based schedule or an event-driven schedule. To that end, the administrative network 404 may provide scheduling data for which media and/or other data transmitted to the casino environment 402 should be propagated to the displays and/or electronic gaming machines within the environment. The schedule may be a time-based schedule or may be an event-based schedule. For example, the schedule may define events within the casino environment 402 which, when detected, cause deployment of at least some of the media content provided by the administrative network 404. As another example, the event-driven schedule may indicate criteria for deploying media or other content, for example, based on outcomes from the EGMs, or the like.

In the casino environment 402, head end system 408 provides a central platform for receiving, processing, and transmitting communication signals between devices within the casino environment 402 and the administrative network 404. According to one or more embodiments, the head end system 408 may include a unified platform rack located on a casino property or other gaming environment that can manage transmissions and data flow between the administrative network 404 and devices within the environment. In some embodiments, the head end system 408 includes a video rendering system to drive various display devices. For example, head end system 408 may drive displays at electronic gaming machines or banks of electronic gaming machines, such as banks 406A-406N. This may include, for example, various displays within a bank, such as displays that are part of EGMs configured to present gaming media data, such as LED displays 416A-416N. In addition, head end system 408 may be configured to drive accessory displays at a bank, such as bank toppers, side lighting, and displays that are available within the bank, such as on seats or other accessory components for the EGMs, on other surfaces of the EGMs and/or the bank, or the like which may present non-gaming media data. For example, LCD display 414 may be a topper display for bank 406A. Head end system 408 can drive the LCD display 414, as well as LED displays 416A-416N. In addition, head end system 408 may be configured to manage additional displays within the casino environment 402. This may include sky domes, media walls, floor displays, casino signage, and the like. Further, the casino environment 402 may have additional displays throughout the environment which may present media data such as casino information, advertisements, scheduling information, or the like. To that end, the head end system 408 may drive LED display 412 and LCD display 410 which are exterior to the banks 406A-406N. In addition, the head end system 408 may be capable of receiving media data from within the casino environment 402, such as a casino management server (not shown).

As described above, the head end system 408 may additionally be capable of managing gaming data, such as machine performance, gameplay outcomes, and the like. Accordingly, head end system 408 may provide a two-way communication channel with the administrative network 404. In some embodiments, head end system 408 may provide gaming data to EGMs 418A-418N via switch 420. For example, bank 406A may include a switch 420 which directs data packets to the correct EGM in the bank 406A, such as among EGMs 418A-418N. The head end system 408 may similarly propagate gaming data to other banks, such as bank 406N in a similar fashion.

The connection between the administrative network 404 and the head end system 408 may provide an on-site solution for propagating updates to electronic gaming machines and may provide technical support for electronic gaming machines within the casino environment 402. In particular, head end system 408 may collect operational data from the electronic gaming machines 418A-418N and provide operational information to the administrative network 404. In doing so, the administrative network 404 can respond efficiently to technical issues which may arise with the EGMs. That is, administrative network 404 may include a service module 426, which is configured to interface with the head end system 408. The service module 426 may receive communication data, for example, from controller 424, and serve as an application programming interface (API) to communicate with the head end system 408, and, optionally, other devices across the network. Controller 424 may be configured to process and generate instructions provided, for example, from a user within the administrative network 404 or automatically generated. View 422 may provide a user interface for a user of the administrative network, for example to provide technical support, provide media or gaming data updates, or the like. Model 428 provides a representation of data available to the administrative network 404, from which controller 424 can generate communication signals for devices within the casino environment 402. For example, model 428 may include a representation of a file system 430, and/or database 432, which may include executable computer code, functional data, media data, and the like. In addition, the database 432 may include scheduling data and other data to be transmitted.

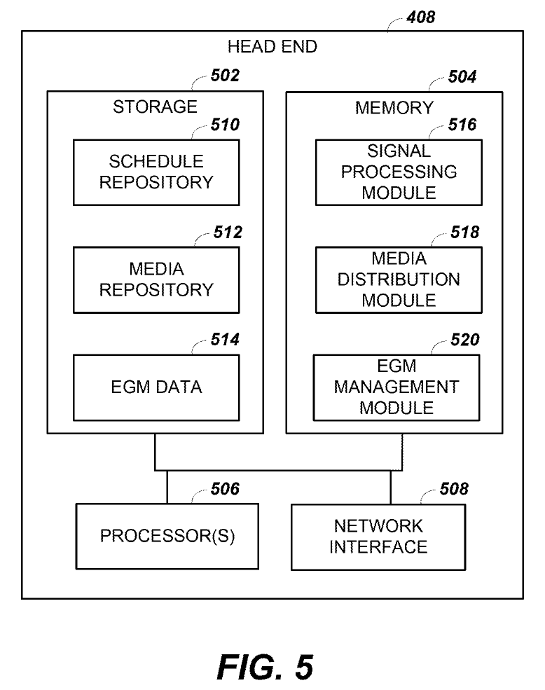

FIG. 5 depicts a system diagram of an example head end system, in accordance with one or more embodiments. The head end system could be a unified platform rack located on the casino property that can utilize a video rendering system to drive numerous display devices, and propagate communication signals between devices within a casino environment and one or more devices across a network.

Head end system 408 is depicted as a single device having storage 502, memory 504, one or more processors 506, and a network interface 508. However, it should be understood that the head end system 408 may be comprised of numerous devices composed into a head end system. Accordingly, the various components and functionality described within head end system 408 may be distributed across multiple devices acting as a single head end system. For example, in some embodiments, the head end system 408 could support over 100+ display devices. Different channel numbers can be assigned to each display or group of displays such that each of one or more electronic gaming displays are assigned to unique communication channels. The head end system 408 may receive, process, and transmit communication signals between the devices and the administrative network 404.

Head end system 408 includes a memory 504. Memory 504 is defined herein as including volatile and nonvolatile memory and other types of non-transitory data storage components. Volatile memory is memory that does not retain data values upon loss of power. Nonvolatile memory is memory that do retain data upon a loss of power. Examples of memory 504 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 5 illustrates that head end system 408 includes a single memory 504, head end system 408 could include multiple memories 504 for storing program instructions and/or data, within a single device, or across multiple devices within the system.

Processor(s) 506 represent a general-purpose processor, a specialized processor intended to perform certain functional tasks, or a combination thereof. As an example, processor(s) 506 can include a central processing unit (CPU) that has one or more multi-core processing units and memory mediums (e.g., cache memory) that function as buffers and/or temporary storage for data. Alternatively, processor(s) 506 can include a specialized processor, such as an application specific integrated circuit (ASIC), graphics processing unit (GPU), field-programmable gate array (FPGA), digital signal processor (DSP), or another type of hardware accelerator. In another example, processor(s) 506 includes a system on chip (SoC) that combines and integrates one or more general-purpose processors and/or one or more specialized processors. Although FIG. 5 illustrates that head end system 408 includes a single processor 506, head end system 408 can include multiple processors (e.g., two or more processors), that may be of a same or different type.

Head end system 408 also includes storage 502. Storage 502 includes one or more nonvolatile storage devices. Examples of storage 502 include hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. Storage 502 is configured to host data which is used by the various programs in memory 504 to provide communication between an administrative network and devices within a casino environment. The data in storage 502 may be stored in one or more types of data structures, and may be stored in a single device, or in multiple storage devices.

An example of computer executable modules in memory 504 includes signal processing module 516. According to one or more embodiments, signal processing module 516 includes computer readable code to process incoming communication signals, for example, from administrative network 404. Signal processing may include, for example, performing rendering tasks such as decoding and/or encoding media data received for propagation to one or more displays in a casino environment. In addition, signal processing module 516 may be configured to determine a target device, such as an EGM or a display, for which a communication is intended, and propagating the processed information accordingly, for example via network interface 508. In addition, the signal processing module 516 may package the data in a format usable by the target device. In some embodiments, the signal processing module 516 may process incoming media or gaming data for later delivery to one or more target devices within the casino environment. As such, storage 502 may include a media repository 512 and electronic gaming machine data 514, which may store data to be transmitted to EGMs or other devices within the casino environment.

As shown, memory 504 also includes a media distribution module 518. According to what embodiments, media distribution module 518 may be configured to monitor a system for determining whether content should be propagated to one or more devices. For example, media distribution module 518 may be configured to receive signals from one or more electronic gaming machines or other devices in the casino environment and determine whether any propagation criteria are satisfied based on a defined schedule. That is, the schedule may be a time-based schedule, an event-driven schedule based on detected events within the casino environment, or some combination thereof. The schedule may be referenced from a schedule repository 510 in storage 502.

Memory 504 also includes an EGM management module 520. The EGM management module 520 may be configured to collect data from EGMs for determination as to whether a trigger event has occurred in accordance with the deployment schedule, to provide performance statistics to the administrative network, or the like. In some embodiments, EGM management module 520 may be used to manage multi-bank progressive games, in which a jackpot or other feature is based on outcomes at multiple EGMs.

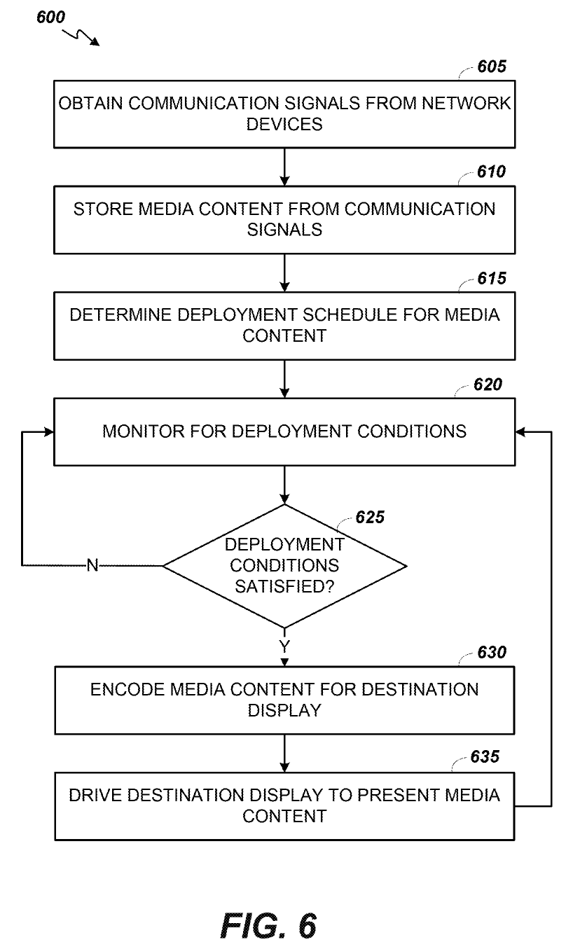

One attribute of the head end system is that numerous displays can be controlled from a central system, including displays at EGMs, and additional displays within a physical environment not related to EGMs. FIG. 6 depicts a flowchart of a technique for using a head end system to drive multiple displays, in accordance with one or more embodiments. For purposes of clarity, the various processes are described as being performed by particular components. However, in some embodiments, the various processes may be performed by additional or alternative components. Although the flow diagram depicts various actions and processes performed in a particular order, it should be understood that in some embodiments, the actions and processes may be performed in a different order. Further, in some embodiments, some or all of the actions may be performed concurrently. In addition, in some embodiments not all processes or actions may be necessary to complete the tasks described, or additional processes or actions may be needed.

The flowchart 600 begins at block 605, where communication signals are obtained from network devices. According to one or more embodiments, communication signals may be received at a head end system from an administrative network. Communication signals may include or identify media or other content to be presented at or propagated to devices communicably connected to the head end system, as well as scheduling information and/or other data to be provided to devices managed by the head end system.

The flowchart 600 proceeds to block 610, where media content is stored from the communication signals. According to one or more embodiments, the head end system may be configured to stream content on demand to devices being managed by the head end system. Alternatively, the head end system may store the information for later deployment, or for use in managing the devices. For example, the media content may include advertising that is to be presented on a predefined schedule. The media content may be stored in a media store, and the schedule may be added to a scheduling repository. This may be beneficial, for example, if a network connection between the head end system and the administrative network is unstable, slow, or otherwise unreliable. Accordingly, by providing on-site storage, the technique provides an improvement to deployment of gaming data and other media data to be deployed within the casino or gaming environment.

At block 615, flowchart 600 includes determining a deployment schedule for the media content. The deployment schedule may be received concurrently with the communication signals, or may be determined automatically, or at another time and/or from the same or different source. For example, the deployment schedule may be stored in or referenced from a schedule repository in the head end system. In some embodiments, the schedule may be received from a same or different source as the content to be deployed. For example, updates to media to be presented on topper displays may be provided by a gaming provider source, whereas the schedule for pushing the updates to the toppers may occur based on a schedule determined by a property owner or manager.

The flowchart 600 proceeds to block 620, where the system is monitored for deployment conditions. In particular, the schedule may indicate particular events which indicate that content should be deployed to devices for presentation within the casino environment with which the head end system is communicatively connected. The deployment conditions may be defined, for example, in a rule set managed by or accessible to the head end system, and may be based on a specific day or time, time interval, or based on conditions on one or more devices within the environment. For example, the deployment conditions in the schedule may indicate criteria for deployment of particular data that arises from a particular outcome on one or more EGMs in the casino environment. Further, the triggering condition may cause presentation at a same or different device. Returning to the example of the outcome of the electronic gaming machine triggering a deployment of content to a display, in some embodiments, content may be displayed on a separate display device from the electronic gaming machine based on an outcome at the electronic gaming machine. For example, a display on the ceiling above an electronic gaming machine for which a jackpot lands may display a celebratory graphic or animation. The display may or may not be directly connected to the EGM or the bank to which the EGM belongs.

At block 625, a determination is made as to whether deployment conditions are satisfied. Deployment conditions may be satisfied based on information received from the administrative network, data received from machines or displays in the casino, or contextual information, such as day, time, and the like. In addition, the deployment condition may be a combination of conditions. If the deployment condition is not satisfied, then the flowchart returns to block 620, and the head end system continues to monitor for deployment conditions.

If, at block 625, deployment conditions are determined to be satisfied, then the flowchart proceeds to block 630. At block 630, media content is encoded for the destination display. For example, the head end system may include a rendering system which renders the content for the particular display device for which the content is to be displayed. This may include encoding the media or generating media content having data parameters which are compatible with the end device, such as frame rate, resolution, and the like. Further, media from multiple sources may be combined to form the media content to submit to the destination display. For example, data from a game source may be combined with data from a property management source, such as a watermark, logo, or the like. The head end system may thus generate a series of frames for propagation to the destination display.

The flowchart 600 concludes at block 635, where the head end system drives the destination display to present the media content. In some embodiments, the head end system may utilize different channels for different displays. For example, different channel numbers can be assigned to each display or group of displays.

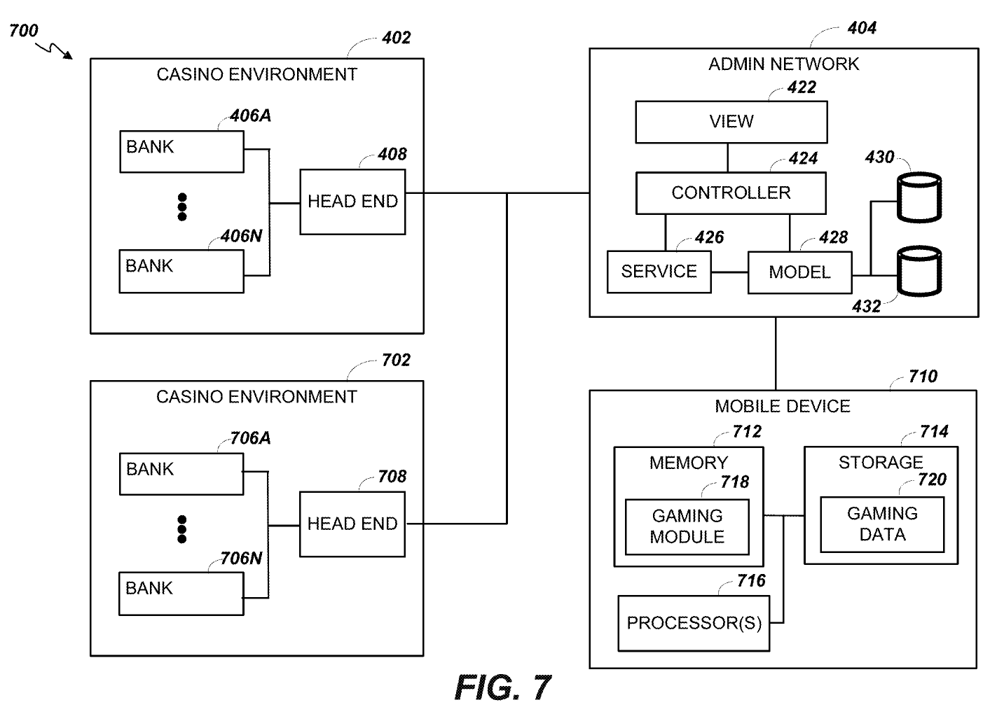

FIG. 7 illustrates example network diagram for a multi-platform gaming architecture, in accordance with one or more embodiments. In particular, system diagram 700 includes administrative network 404 serving a centralized role and connected to the casino environment 402, along with other gaming devices, such as devices within casino environment 702. In addition, administrative network 404 may be communicably connected to devices having different platforms. For example, as shown, administrative network 404 is communicably connected to mobile device 710. Accordingly, in some embodiments, the administrative network may be capable of two-way communication enabled by the head end systems 408 and 708 to manage multi-platform gaming, and multi-site features such as progressive jackpots and the like. Accordingly, activity from within casino environment 402, as provided by head end system 408, may affect content provided to other devices, such as gaming devices within casino environment 702, and/or an online version of the game on mobile device 710. Thus, each casino environment may have a head end system which is communicably coupled to the administrative network 404. While head end system 408 provides a central communication channel for devices within casino environment 402 to communicate with administrative network 404, head end system 708 provides a central communication channel for devices within casino environment 702 to communicate with administrative network 404.

According to one or more embodiments, administrative network 404 may communicate with multiple types of devices, including mobile device 710. Mobile device 710 may include an electronic device configured to communicate with administrative network 404 across a network. Mobile device 710 may comprise a smartphone, a tablet, a laptop, a wearable device, or any other device that has a processor 716, a memory 712, and a storage 714. In some embodiments, mobile device 710 may be configured to provide a mobile version of a game, which may be the same or differ from games hosted on electronic gaming machines. Further, in some embodiments, the administrative network 404 may be communicably connected to one or more other computing devices which may or may not be mobile devices, and which are also configured to provide other versions of the game, such as mobile versions, desktop versions, game console version, or the like.

Mobile device 710 includes one or more processors 716. Processor 716 represents a general-purpose processor, a specialized processor intended to perform certain functional tasks, or a combination thereof. As an example, processor 716 can be a central processing unit (CPU) that has one or more multi-core processing units and memory mediums (e.g., cache memory) that function as buffers and/or temporary storage for data. Alternatively, processor 716 can be a specialized processor, such as an application specific integrated circuit (ASIC), graphics processing unit (GPU), field-programmable gate array (FPGA), digital signal processor (DSP), or another type of hardware accelerator. In another example, processor 716 is a system on chip (SoC) that combines and integrates one or more general-purpose processors and/or one or more specialized processors. In some embodiments, mobile device 710 can include multiple processors 716 (e.g., two or more processors), and may be of a same or different type.

Memory 712 is defined herein as including volatile and nonvolatile memory and other types of non-transitory data storage components. Volatile memory is memory that does not retain data values upon loss of power. Nonvolatile memory is memory that do retain data upon a loss of power. Examples of memory 712 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 7 illustrates that mobile device 710 includes a single memory 712, mobile device 710 could include multiple memories 712 for storing program instructions and/or data.

An example of computer executable modules in memory 712 includes a gaming module 718. Gaming module 718 may include executable code for providing an electronic game on the mobile device 710. In some embodiments, the gaming module 718 may receive gaming data from administrative network 404, and some characteristics of the game in the gaming module 718 may be dependent upon actions or context at other gaming devices, such as EGMs at banks 406A-406N, or EGMs at banks 706A-706N.

Mobile device 710 may also include a storage 714. Examples of storage 714 include hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. Storage 714 is configured to host data which is used by the various programs in memory 712, such as gaming module 718. For example, memory 712 may include gaming data 720 which may be retrieved during execution of the gaming module 718 to provide an electronic game on the mobile device. Examples include game-specific data, and/or user-specific data. The gaming data 720 may be stored in one or more types of data structures, and may be stored in a single device, or in multiple storage devices. In some embodiments, the gaming data 720 may include data received from administrative network 404.

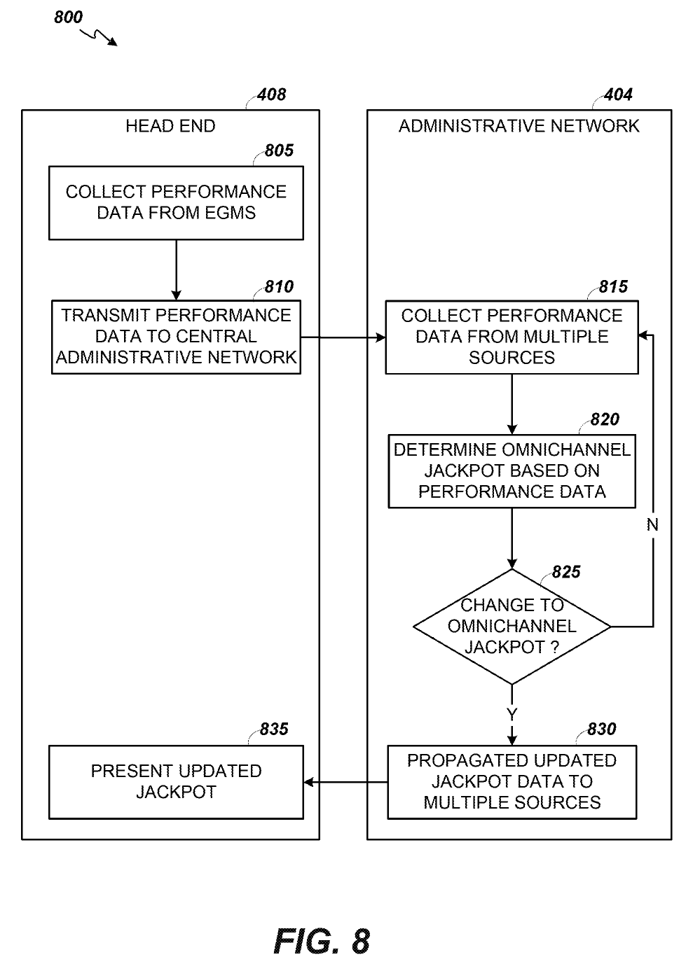

FIG. 8 depicts a flow diagram for facilitating a multi-site progressive, in accordance with one or more embodiments. In particular, FIG. 8 depicts communication between an example head end system 408 and administrative network 404. However, it should be understood that administrative network 404 may be communicably coupled to other computing devices hosting a same or different version of a game.

For purposes of clarity, the various processes are described as being performed by particular components. However, in some embodiments, the various processes may be performed by additional or alternative components. Although the flow diagram depicts various actions and processes performed in a particular order, it should be understood that in some embodiments, the actions and processes may be performed in a different order. Further, in some embodiments, some or all of the actions may be performed concurrently. In addition, in some embodiments not all processes or actions may be necessary to complete the tasks described, or additional processes or actions may be needed.

The flow diagram 800 begins at block 805, where the head end system 408 collects performance data from connected EGMs. As described above, the head end system 408 may be communicably coupled to numerous EGMs within a casino environment or other gaming environments, for example in the case of a wide area progressive game. The EGMs may pass data related to EGM performance, including gaming metrics, jackpot activity, game outcome, and the like. In addition, EGMs may pass other data to the head end system 408 such as data related to the operability of the individual machines.

The flow diagram 800 proceeds to block 810, where the head end system 408 transmits performance data to the central administrative network 404. For example, the head end system may transmit real time gaming data associated with the game performance on associated EGMs. In some embodiments, the head end system 408 may encode the performance data such that it is packaged in a structure anticipated by the administrative network 404.

The flow diagram 800 proceeds to block 815, where the administrative network collects performance data from multiple sources. That is, the administrative network 404 may collect the performance data from head end system 408, and one or more additional head end systems from other gaming environments. In some embodiments, the administrative network 404 may additionally collect performance data from other types of platforms, such as the mobile device described above with respect to FIG. 7.

At block 820, the administrative network determines an omnichannel jackpot based on the performance data. In particular, based on game performance at the on the multiple platforms, the administrative network 404 may include logic configured to determine a common jackpot across all active devices, or a particular subset of devices. The jackpot may be a single value, or may differ based on the platform. In some embodiments, the omnichannel jackpot may be determined for EGMs in multiple physical environments, such as casinos or other gaming environments. Additionally, or alternatively, the administrative network 404 can determine the omnichannel jackpot for a combination of EGMs at one platform type, such as casinos, and other gaming devices, such as a mobile device executing a mobile gaming version of a same game as EGMs.

A determination is made at block 825 as to whether a change to the omnichannel jackpot has occurred based on the performance data. If a change has not occurred, then the flow diagram 800 returns to block 815, and the administrative network 404 continues to receive performance data from the various sources until the performance data indicates a change to the omnichannel jackpot.

If at block 825 a determination is made that the change to the omnichannel jackpot has occurred, then the flow diagram 800 proceeds to block 830. At block 830, the administrative network 404 propagates the updated jackpot data to the multiple sources. This includes providing the jackpot information to the head end system 408 for propagation to the active EGMs, as well as other head end systems or devices hosting versions of the same game for which the omnichannel jackpot is determined.

The flow diagram 800 concludes at block 835, where the updated jackpot is presented. In particular, the head end system 408 can encode and propagate data related to the updated jackpot to the corresponding EGMs and/or other display devices in the physical casino. For example, the head end system 408 may include a rendering system that generates updated image data for presentation at the EGMs related to the jackpot. The head end system 408 may control the displays at the EGMs to present the updated jackpot information. In addition, and some embodiments, head end system 408 may render image data with the with the updated jackpot information for presentation at additional displays. For example, the head end system 408 may control display of a topper of a bank at which an EGM is active in the game associated with the omnichannel jackpot. Thus, the head end system 408 may render image data for presentation at the topper. In addition, the head end system 408 may render image data based on the updated jackpot information for presentation at other displays in the casino that may or may not be associated with the active EGMs for which the omnichannel jackpot is determined. For example, image data for the updated jackpot may be rendered and displayed on non-gaming displays, such as display panels within the casino, on walls, on ceilings, on the floor, on seating or other furniture, or the like.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A system comprising:
one or more processors; and
one or more storage devices comprising computer readable code executable by the one or more processors to:
dynamically receive a plurality of communication signals associated with a plurality of media data from a source device,
determine, based on the plurality of communication signals, that first media content of the media data is directed to a first electronic gaming machine (EGM) display in a gaming environment and that the first media content corresponds to a first deployment schedule,
determine a first communication channel of a plurality of communication channels assigned to the first EGM display,
drive the first EGM display to display the first media content by transmitting the first media content over the first communication channel based on the first deployment schedule,
determine, based on the plurality of communication signals, that second media content of the media data is directed to a first non-EGM display in the gaming environment and that the second media content corresponds to a second deployment schedule,
determine a second communication channel of the plurality of communication channels assigned to the first non-EGM display, and
drive the first EGM display to display the second media content by transmitting the second media content over the second communication channel based on the second deployment schedule.

2. The system of claim 1, wherein the first deployment schedule comprises a rule set for causing the first media content to be displayed.

3. The system of claim 2, wherein the rule set comprises a deployment condition based on an outcome of at least one of a plurality of electronic gaming machines.

4. The system of claim 1, wherein the first non-EGM display is separate from the first EGM display.

5. The system of claim 1, further comprising:
a rendering system comprising computer readable code to:
render the first media content, and
independently drive the first EGM display and one or more additional EGM displays using the rendered first media content.

6. The system of claim 1, further comprising computer readable code to:
receive gaming data from a network device;
propagate the gaming data to a first plurality of EGMs at a first bank by transmitting the gaming data to a first switch corresponding to the first bank; and
propagate the gaming data to a second plurality of EGMs at a second bank by transmitting the gaming data to a second switch corresponding to the second bank.

7. The system of claim 1, further comprising computer readable code to:
collect operational data from a plurality of EGMs; and
transmit the operational data to the source device.

8. A non-transitory computer readable medium comprising computer readable code executable by one or more processors to:
dynamically receive a plurality of communication signals associated with a plurality of media data from a source device;
determine, based on the plurality of communication signals, that first media content of the media data is directed to a first electronic gaming machine (EGM) display in a gaming environment and that the first media content corresponds to a first deployment schedule;
determine a first communication channel of a plurality of communication channels assigned to the first EGM display;
drive the first EGM display to display the first media content by transmitting the first media content over the first communication channel based on the first deployment schedule;
determine, based on the plurality of communication signals, that second media content of the media data is directed to a first non-EGM display in the gaming environment and that the second media content corresponds to a second deployment schedule;
determine a second communication channel of the plurality of communication channels assigned to the first non-EGM display; and
drive the first EGM display to display the second media content by transmitting the second media content over the second communication channel based on the second deployment schedule.

9. The non-transitory computer readable medium of claim 8, wherein the first deployment schedule comprises a rule set for causing the first media content to be displayed.

10. The non-transitory computer readable medium of claim 9, wherein the rule set comprises a deployment condition based on an outcome of at least one of a plurality of electronic gaming machines.

11. The non-transitory computer readable medium of claim 8, further comprising computer readable code to:
render the first media content; and
independently drive the first EGM display and one or more additional EGM displays using the rendered first media content.

12. The non-transitory computer readable medium of claim 8, further comprising computer readable code to:
receive gaming data from a network device;
propagate the gaming data to a first plurality of EGMs at a first bank by transmitting the gaming data to a first switch corresponding to the first bank; and
propagate the gaming data to a second plurality of EGMs at a second bank by transmitting the gaming data to a second switch corresponding to the second bank.

13. The non-transitory computer readable medium of claim 8, further comprising computer readable code to:
collect operational data from a plurality of EGMs; and
transmit the operational data to the source device.

14. A method comprising:
dynamically receiving a plurality of communication signals associated with a plurality of media data from a source device;
determining, based on the plurality of communication signals, that first media content of the media data is directed to a first electronic gaming machine (EGM) display in a gaming environment and that the first media content corresponds to a first deployment schedule;
determining a first communication channel of a plurality of communication channels assigned to the first EGM display;
driving the first EGM display to display the first media content by transmitting the first media content over the first communication channel based on the first deployment schedule;
determining, based on the plurality of communication signals, that second media content of the media data is directed to a first non-EGM display in the gaming environment and that the second media content corresponds to a second deployment schedule;
determining a second communication channel of the plurality of communication channels assigned to the first non-EGM display; and
driving the first EGM display to display the second media content by transmitting the second media content over the second communication channel based on the second deployment schedule.

15. The method of claim 14, wherein the first deployment schedule comprises a rule set for causing the first media content to be displayed.

16. The method of claim 15, wherein the rule set comprises a deployment condition based on an outcome of at least one of a plurality of electronic gaming machines.

17. The method of claim 14, wherein the first non-EGM display is separate from the first EGM display.

18. The method of claim 14, further comprising:
rendering the first media content, and
independently driving the first EGM display and one or more additional EGM displays using the rendered first media content.

19. The method of claim 14, further comprising:
receiving gaming data from a network device;
propagating the gaming data to a first plurality of EGMs at a first bank by transmitting the gaming data to a first switch corresponding to the first bank; and
propagating the gaming data to a second plurality of EGMs at a second bank by transmitting the gaming data to a second switch corresponding to the second bank.

20. The method of claim 14, further comprising:
collecting operational data from a plurality of EGMs; and
transmitting the operational data to the source device.
